(19) United States
(12) Patent Application Publication
(10) Pub. No.: US 2025/0312874 A1
(43) Pub. Date: Oct. 9, 2025

(54) AN AUTOMATED TORQUE DEVICE FOR INSTALLING AND EXTRACTING FASTENING ELEMENTS FOR MILL LINERS

(71) Applicant: MI ROBOTIC SOLUTIONS S.A., Santiago (CL)

(72) Inventors: Hugo César SALAMANCA POBLETE, Santiago (CL); Luis Alejandro BAEZA RAMÍREZ, Santiago (CL); Angelo DE DOMINICIS RODRÍGUEZ, Santiago (CL); Mario Francisco POBLETE GUTIÉRREZ, Santiago (CL)

(73) Assignee: MI ROBOTIC SOLUTIONS S.A., Santiago (CL)

(21) Appl. No.: 18/872,901

(22) PCT Filed: Jun. 10, 2022
(86) PCT No.: PCT/CL2022/050061

§ 371 Date: Dec. 9, 2024

(51) Int. Cl. B23P 19/08; B02C 17/22; B25J 9/16; B25J 15/02; B25J 15/04

(52) U.S. Cl. CPC B23P 19/08; B25J 9/1687; B25J 15/0253; B25J 15/04; B02C 17/22

(57) ABSTRACT

The present invention relates to an automated torque device or tool for the installation and extraction of fastening elements for mill liners, such as nuts and washers, with a high torque capacity and controlled speed for the installation and/or extraction of the fastening elements of mill liners, comprising at least one powertrain means (2), at least one axial compensation means (3), at least one radial compensation means (4), at least one grip element (5), at least one tool exchanging means (6), at least one chassis (7), and at least one communication and control means (8) which allows generating the necessary information and providing feedback to the system for operating the tool by means of different sensors arranged in the different components of the tool.

### FIELD OF THE INVENTION

The present invention relates to devices, tools, and/or methods used for installing, applying torque, and extracting the fixing means for wear elements, such as liners or guards, which are arranged on the inner surface of the casing of a mill for mineral milling in the mining industry.

Preferably, the invention relates to an electric torque device or tool for the installation and extraction of fastening and/or fixing elements or means for a mill liner or guard such as, for example, nuts, bolts, and/or washers, the configuration of which allows obtaining the tension required by the bolted attachment during installation, as well as the torque required for extraction, and allows extraction and installation through an automated process, without needing the intervention of any maintenance personnel to handle said device or tool, such that the liner replacement process is optimized, ensuring a correct installation and extraction of said fastening elements with respect to each liner that will be changed, achieving a higher degree of certainty and efficiency, therefore optimizing mill shutdown time for maintenance, unscheduled shutdowns for repair through a process that is carried out poorly, and preventing maintenance personnel from being exposed to the risks associated with this type of method.

### BACKGROUND OF THE INVENTION

The extraction of fixing elements from mill liners to carry out their replacement constitutes a highly repetitive process as a large number of fixing elements must be used to enable correctly and securely fix the large number and variety of liners that a mill comprises inside its casing.

Liner replacement in the art requires the use of tools or devices that are normally operated by the personnel directly in the replacement area that help the positioning, guiding, fixing, and/or loosening of the liners, this being a high risk process for the personnel involved in the replacement operation, as well as entailing a longer time associated with the maintenance operation.

Liners, which have a different configuration, size, and shape according to their location, are installed on the inner surface of the mill, being fixed and/or fastened by fixing means. One of the ways used for fixing consists of a bolt which is inserted into a hole of the liner and the mill shell, such that one threaded end of said bolt projects outwardly from the mill shell on the outer part thereof to allow the arrangement of a sealing element, such as a cup washer or vulcanized washer, and a tightening element, such as a nut, which is tightened with the necessary, normally high torque, to tighten and therefore securely fix the liner to the inner surface of the mill shell, and provide the necessary sealing to prevent leakage of pulp from inside the mill through said fixing means.

Another way of fixing is to use liners with a thread therein, in this case only the liner is positioned and mounted from the inside, while from the outside a bolt is introduced into the hole of the mill and screwed onto the thread of the liner, achieving fixing.

The liner replacement method is normally carried out with tools that are operated by maintenance personnel to carry out each of said tasks involved in said replacement, such as using tools that allow loosening and removing the nuts and/or bolts, tools or elements that allow removing the washers, tools for pushing the bolts into the mill, tools for removing the liner from its location inside the mill, and wherein for liner installation, there is a need to carry out each of said indicated steps in reverse order.

One of the most time consuming steps to perform in the liner replacement process is related to the steps of loosening, removing, inserting, and tightening the nuts from the threaded rod exposed on the outside of the mill from the liner fixing and fastening bolt, since a large number of personnel is required to loosen a large number of fixing means comprised in the large number of liners used in a mill, as well as the tools required to loosen the nut in each of the different types of existing mills, and the number of different tasks that must be carried out in the extraction and insertion of a fixing means for a liner.

Since the fixing means is exposed to adverse environments, it is normally cleaned and lubricated manually in its threaded area by means of a brush or pieces of cloth to facilitate its extraction or insertion, then, in the fixing means installation process, the nut or bolt is pre-installed manually in the arrangement to be fixed in order to proceed to pre-tightening with a tool that is normally an impact tool, such as a pneumatic tool, to then proceed to final torque tightening with a torque tool, which can be a hydraulic or electric tool. To carry out the fixing means extraction process, after cleaning and lubrication, the other steps are carried out in reverse to loosen a nut or bolt.

As each of the steps in the process for extracting and installing the fixing means of a liner for replacement are carried out by a large number of personnel, as well as with a large number of different tools, and under extreme working conditions, the scheduled shutdown time is usually extended, making the process less efficient, however, often times in order to comply with said program, the large number of maintenance personnel carrying out said method does not optimally perform each of the various steps or tasks to extract or install the fixing means of a liner, which normally leads to system failures, such as leakage due to sealing loss and liner detachment, resulting in subsequent unscheduled shutdowns for repair. The adverse conditions in which said method is carried out by personnel increase the risk of sustaining accidents.

A series of devices, tools, and methods have been developed and implemented in the art, which are intended for solving the problems associated with the removal and insertion of fixing means in the replacement of a mill liner, such as the one described in national application 2642-2005 (MI ROBOTIC SOLUTIONS S.A.) with publication date Jan. 6, 2007 and corresponding to National Registration 49044, which describes a robotic method for the method for removing bolts from SAG mills, which in turn comprises providing a robotic arm with at least 5 degrees of freedom, taking a nut cutting tool from a tool rack, cutting or loosening the nut, and taking a bolt removal tool to dispose of a mill fastening bolt. This document does not specify the shape and structural configuration of the tools, but only describes that the robotic arm takes a tool to cut or loosen the nut and a bolt remover tool, only indicating that it corresponds to hydraulic equipment, and describing that the tool rack also comprises a torque wrench and tools to tighten and loosen bolts.

Moreover, national application Ser. No. 20/170,2310 (IVAN JORGE PEREZ GUTIERREZ) with filing date Dec. 9, 2017 describes a bolt removal and tightening system for mill liners comprising a rail fixed to an operating platform, a movable and tilting support that can take different positions along the rail, allowing the wrench to be positioned facing various bolt runs depending on the position taken by the movable and tilting support, wherein the wrench that applies torsion on the bolt is of the planetary gearbox motor type, with the motor being actuated electrically, hydraulically, pneumatically, with a toothed ratchet or friction ratchet. Although it is true that a tightening system is described in which there is a means which allows facilitating the mobility of the torsion tool to the different points where the process of removing and tightening the bolts of a mill liner is to be carried out, the system, however, still considers the manual operation of the wrench to apply pressure until the relief valve of the hydraulic unit cuts off the power supply to the motor.

An apparatus and method for extracting quick-extraction nuts is disclosed in national application Ser. No. 20/170,0082 (DESARROLLO Y OPTIMIZACION DE SISTEMAS PRODUCTIVOS S.A.) with filing date Dec. 1, 2017, the configuration of which allows fast and efficient disassembly and dismantling of a quick-extraction nut, wherein the apparatus comprises a hydraulic cylinder which has a nut supported on the end of the bolt, in addition to two jaws that surround, from the base, the outer body of the nut which, upon the contraction of the jaws and the actuation of the hydraulic cylinder, extract said outer body, whereby the pins and split bushing of the inner hollow body come out of their position, leaving the nut dislodged and freeing the end of the bolt, which maintains the attachment of the mill drum to the inner liner. Although it is true that this proposed solution facilitates the extraction of a fixing means of a mill liner, it however requires direct handling by maintenance personnel given the need to position the hardened liner of the device in a fixed manner at the end of the bolt in order to actuate a crank by rotating it, which allows actuating the jaws to surround the nut and closing the jaws, for the subsequent operation by the operator of the hydraulic cylinder which, by moving the rod, the outer body of the nut is extracted therefrom.

The solutions described in the prior art, by considering the suspension of tools, actuation through the displacement of rails, and/or telescopic arms, as well as requiring the manual operation of more than one tool in more than one of the tasks involved in the extraction and installation of the fixing elements of the mill liner, lead to errors in the method such as, for example, poor alignment of the tool, poor operation, among others, which by requiring a large number of personnel to carry out the process, make it less efficient and more risky.

Therefore, there is a need in the art to provide a torque device or tool for the installation and extraction of fastening elements for mill liners the operation of which is automated and electrically operated with a high torque capacity for extracting, removing, tightening, and/or fixing the fastening elements for a mill liner or guard such as, for example, nuts, bolts, and/or washers, the configuration of which allows obtaining the tension required by the bolted attachment during installation, as well as the torque required for extraction, and allows compensating for deviations in the movement of the tool during the installation and/or extraction of said fastening elements, and carrying out at the same time each of the tasks involved in a fast, efficient, and accurate manner, wherein the operation of said device or tool is automated and remote, so as to prevent the intervention of maintenance personnel and to prevent errors that normally occur with the systems, apparatus, devices, tools, and methods used in the state of the art.

### SUMMARY OF THE INVENTION

The object of the present invention is to provide an automated torque device or tool for the installation and extraction of fastening elements for mill liners, with a large torque capacity and controlled speed for the installation and/or extraction of the fastening elements of mill liners, either for fixing elements with a nut and washer on the outside of the mill or for fixing elements that are screwed from outside the mill, without requiring the intervention of any maintenance personnel, and the configuration of which allows compensating for deviations in the position of the tool during the installation or extraction of said fastening elements, thereby optimizing the process, making it the most efficient, effective, and safe.

The invention consists of a robotically-actuated, automated electric torque device or tool (1) for the installation and extraction of fastening elements for mill liners, such as washers, nuts, and/or bolts, with a large torque capacity and controlled speed, comprising at least one powertrain means (2), at least one axial compensation means (3), at least one radial compensation means (4), at least one grip element (5), at least one tool exchanging means (6), at least one chassis (7), and at least one communication and control means (8) which allows generating the necessary information and providing feedback to the system for operating the tool by means of different sensors arranged in the different components of the tool.

The configuration of the remotely-actuated, automated electric torque device or tool with a large torque capacity and controlled speed for the installation and/or extraction of the fastening elements for mill liners, such as washers, nuts, and/or bolts, allows rendering the capacity of provide a movement in plane X, Y, and Z in order to compensate for deviations in the installation and/or extraction of the liner fixing means for a mill, being capable of supporting washers and nuts in the case of fixing through nut and bolts in the case of those directly screwed onto the liner, and wherein it is capable of generating the torque necessary for the installation of the fixing means for a mill liner, measuring the torsion and the angle of installation

The automated electric torque device or tool with a large torque and controlled speed for the installation and/or extraction of the fixing means for mill liners such as, washers, nuts, and/or bolts, allows each of the tasks, such as installation, loosening, extraction, tightening, and final torque application, involved in the extraction and/or insertion of the fixing means for the liner to be carried out with the same device by means of automatic operation and actuation, thereby providing a remotely-actuated, automated device or tool which allows ensuring process quality, certainty, and effectiveness, therefore optimizing the mill shutdown time for maintenance and preventing maintenance personnel from being exposed to the risks associated with this type of method.

### DESCRIPTION OF THE DRAWINGS

In order to help to better understand the features of the invention according to a preferred practical embodiment thereof, a set of drawings is attached as an integral part of the description in which the invention is depicted in an illustrative and non-limiting manner.

FIG. 1 corresponds to an exploded top side perspective view showing the basic elements constituting the torque device or tool for the extraction and installation of the fastening elements for mill liners of the present invention.

FIG. 2 corresponds to an exploded top side perspective view of a powertrain means of the torque device or tool for the extraction and installation of the fastening elements for mill liners of the present invention.

FIG. 3 corresponds to an exploded top side perspective view of an axial compensation means of the torque device or tool for the extraction and installation of the fastening elements for mill liners of the present invention.

FIG. 4 corresponds to an exploded top side perspective view of a radial compensation means of the torque device or tool for the extraction and installation of the fastening elements for mill liners of the present invention.

FIG. 5 corresponds to an exploded side perspective view of a grip element of the torque device or tool for the extraction and installation of the fastening elements for mill liners of the present invention.

FIG. 6 corresponds to an exploded top side perspective view of a tool exchanging means of the torque device or tool for the extraction and installation of the fastening elements for mill liners of the present invention.

FIG. 7 corresponds to an exploded top side perspective view of a chassis of the torque device or tool for the extraction and installation of the fastening elements for mill liners of the present invention.

### PREFERRED EMBODIMENT OF THE INVENTION

The invention consists of a remotely-actuated, automated electric torque device or tool (1) with a large torque capacity and controlled speed for the installation and/or extraction of the fastening elements for mill liners, such as washers, nuts, and/or bolts, wherein said electric torque device or tool (1), as seen in FIG. 1, basically comprises at least one powertrain means (2), at least one axial compensation means (3), at least one radial compensation means (4), at least one grip element (5), at least one tool exchanging means (6), at least one chassis (7), and at least one communication and control means (8) which allows generating the necessary information and providing feedback to the system for operating the tool by means of different sensors arranged in the different components of the tool.

The chassis (7), which corresponds to the support structure of the different elements comprising the electric torque device or tool (1), as can be seen in FIG. 7, is configured by a series of elements attached to one another, such as opposing lateral plates that are spaced apart from one another (9), an upper plate (10), and a front plate (11) attached to one another through their edges by means of fastening elements (14) forming a support structure with an inner housing, and the object thereof is to contain all the means and elements or subsystems that the device comprises, protect the tool, and structurally contain the forces and momentums generated due to the work of the electric torque device or tool (1), wherein the upper plate (10) comprises rail support plates (12) on both sides, at least one lateral plate (9) comprises an anchoring centering element (13) attached thereto by means of fastening elements (14), a second compensating plate (15) is attached in the front part of the front plate (11) by means of the fastening elements (14) and wherein both the front plate (11) and said compensating plate (15) comprise a central opening (16), furthermore the upper edge of the front plate (11) comprises linear rail adjustment strips (17) and the lower edge comprises lateral linear guide retainers (18).

As seen in FIG. 1, the front plate (11) of the chassis (7) has a configuration and shape such that it allows the fixing and/or attachment of the assembly of the at least one grip element (5) and of at least one radial compensation element (4) and the rear end of the open chassis (7) has a shape and configuration allowing the fixing, arrangement, and/or attachment of the at least one powertrain means (2).

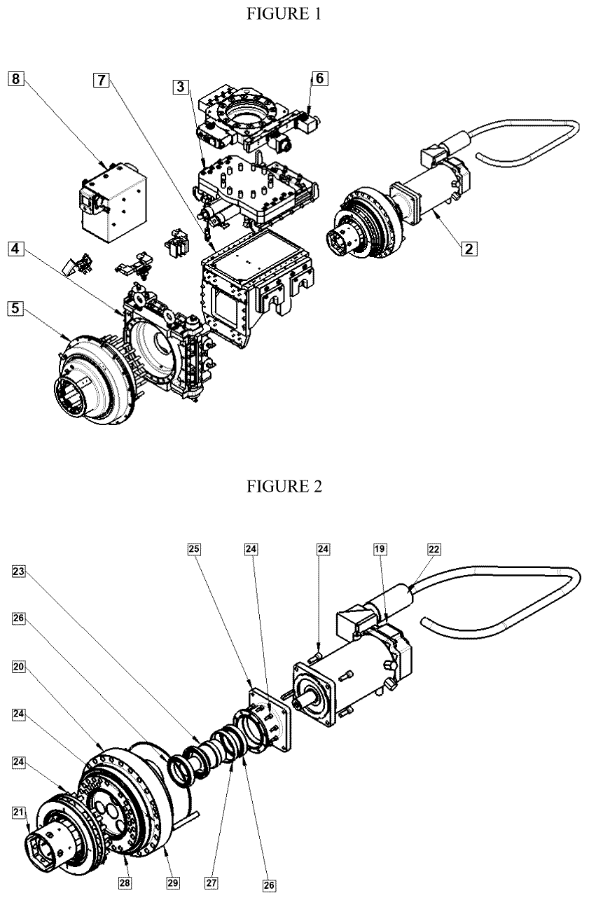

The powertrain means (2), illustrated in FIG. 2, allows transmitting the torque from a drive system to the bolted attachment, generating the required tension, and is basically formed by a servomotor (19) which is attached to a planetary gearbox (20) and this is in turn attached to the die (21), allowing the application of a torque and controlled speed according to process requirements, the servomotor (19) comprises a power unit routing element (22) attached at the rear end by means of fastening and sealing elements (24), and a servo mount (25) in its front part through fastening and sealing elements (24), wherein said servo mount comprises a housing that is prolonged at the front part thereof in which there is housed an assembly formed by a spindle (23) on which there are mounted on both opposite sides a ball rolling assembly (26) and a separator ring (27). The planetary gearbox (20) comprises a central attachment element (28) in its front part to which the die (21) is attached by means of fastening and sealing elements (24), and wherein furthermore said planetary gearbox has a perimeter body ring (29) with attachment holes along the entire perimeter thereof.

As illustrated in FIG. 4, the at least one radial compensation element (4) generates a movement tolerance in directions X and Y of the tool, said movement tolerance being caused by pneumatic cylinders and being necessary for the tool to lose rigidity and help in the fitting of the hexagon of the tool and the nut to be extracted, or in introducing the bolt the thread of the liner, with the radial compensation element comprising a gearbox casing (30) and a first compensating plate (31) which have central openings and are attached to one another by means of a vertically arranged pneumatic movement assembly formed by a cylinder support (32) in which a pneumatic cylinder (33) is arranged, wherein on both the upper edge and the lower edge of the gearbox casing (30) opposite one another there are arranged said assemblies of cylinder support (32) with the pneumatic cylinder (33) and on each left and right side of said casing (30) facing the first compensating plate (31), wherein there is arranged between each of said opposing assemblies of cylinder support (32) and pneumatic cylinder (33) a linear rail (34) which is attached to linear guides with the recirculation of balls (35) that are fixed to the opposing face of the first compensating plate (31), whereby movement tolerance in the direction of axis Y of the tool is generated. A horizontally arranged pneumatic movement assembly formed by a cylinder support (32) in which a pneumatic cylinder (33) is arranged on the rear face of the first compensating plate, such that at least two assemblies of support and pneumatic cylinder are fixed facing and spaced apart from one another between which there is arranged a linear rail (34) which is attached to linear guides with the recirculation of balls (35) that are fixed to the second compensating plate (15) which is attached in the front part of the front plate (11) of the chassis (7), whereby movement tolerance in the direction of axis X of the tool is generated. Said pneumatic movement assemblies are operated by a valve arrangement (36) with a manifold (37) and a connector (38) arranged in the radial compensation element (4).

The at least one radial compensation element (4), as assembled and described above and arranged in the tool or device (1) in the open front plate (11) of the chassis (7), allows rendering a movement in planes X and Y in order to compensate for deviations in the installation and/or extraction of the fastening elements for mill liners.

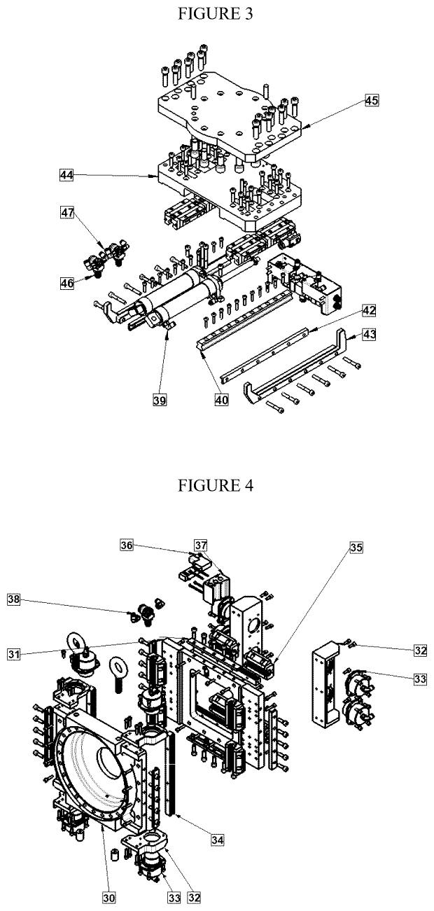

As illustrated in FIG. 3, the axial compensation means (3) generates a movement tolerance in the axial direction in Z of the tool, allowing the fitting between the hexagon of the tool and the nut, also allowing the displacement of the nut during the removal of the bolt, in the extraction process, the movement in Z is generated by means of double-effect pneumatic cylinders (39), and wherein the tool displace over two linear rails (40) and four linear guide carriages (41). The movement support assembly is configured by a lateral retainer (42) having at its ends a linear guide compensating stop (43) to which the linear rail (40) is attached, this assembly being fixed or attached on both sides to the rail support plate (12) comprising the upper plate (10) of the chassis (7). There is attached to the linear rail a linear guide carriage (41) which is fixed on the lower face of a guide support plate (44), on both sides of said plate (44), wherein said plate has a central recess in which at least one double-effect pneumatic cylinder (39) is arranged and attached, whereby movement tolerance Z of the tool is generated. On the upper face of the guide support plate (44) there is fixed an exchanger fastening plate (45) that is attached to the tool exchanging means (6). The actuation of the cylinders (39) is carried out by means of a valve having an air regulator (46) with a connector (47).

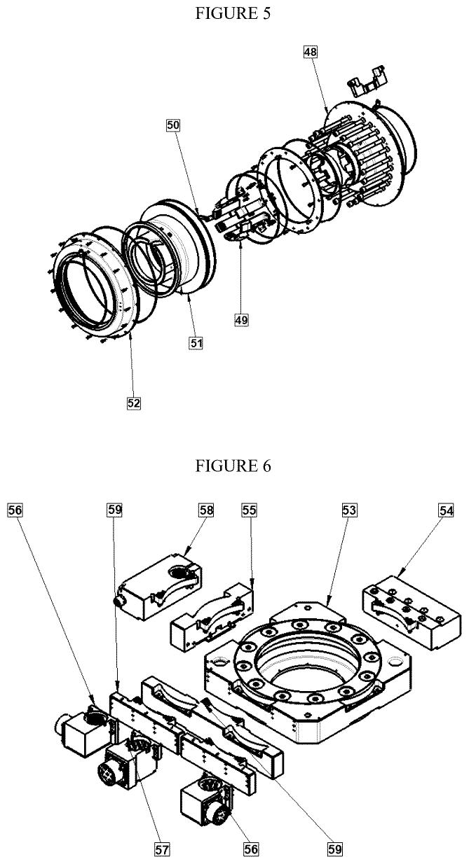

The grip element (5), as illustrated in FIG. 5, performs the function of holding the washer for installation and extraction, or allows grabbing the bolt in the case of liners with thread, and allows dissipating the torque from the reaction produced by the tool, so that it is not absorbed entirely by the robot. The grip element (5) is formed by a central ring (48) having a central opening in which there are fixed, in a forwardly projecting manner, the grip fingers (49) which are surrounded by an opening and closing actuation assembly formed by a bolt head or nut retention system (50), a grip piston (51), and a gripping cylinder (52), such that the grip piston (50), that is pneumatically actuated, is responsible for generating the closing and opening of the fingers of the grips (49) that holds the washer or the bolt. The grip element (5) is attached to the central opening of the gearbox casing (30) of the radial compensation element (4).

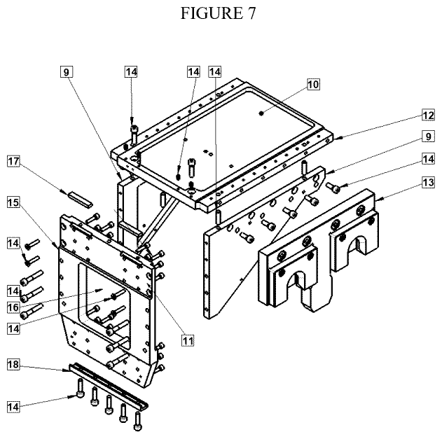

The tool exchanging means (6), seen in the illustration of FIG. 6, which allows quickly changing one tool for another, and also transfers the energy necessary for the operation thereof, is formed by a base (53) having a body formed by a central opening and a body perimeter having a series of holes for the fixing of fastening elements to be fixed to the exchanger fastening plate (45) of the axial compensation means (3), wherein there are attached on the perimeter sides of the body of the base a module for water (54), a spacer (55), an electric module (56), a current module (57), a communications module (58), and adapters for expanding and installing modules (59).

The communication and control means (8) allows generating the necessary information and providing feedback to the system for operating the tool by means of different sensors arranged in the different components of the tool, inside which at least one sensor and limit switch actuator, at least one open and closed grip sensor, at least one laser sensor for detecting movement in Z, and at least one die rotation sensor are located.

The method of installing the fastening elements of a liner, i.e., a nut and/or a bolt, is carried out by means of transferring the automatic electric torque device or tool (1) for the extraction and installation by means of an automatic manipulator such as, for example, a robotic manipulator, to a feeding system for feeding the fastening elements, i.e., a nut with a washer or bolt, which are held with the grips, once said task has been performed, the manipulator brings the device or tool (1) to its working position, with the fastening elements facing and in alignment with the bolt of the mill or thread of the liner, photographs are taken with artificial vision for alignment, and the fastening elements are installed in the mill with a set torque being applied to subsequently loosen the components of the fastening elements by opening the grips, and then returning to the feeding position to repeat the process.

In the method for removing or extracting the fastening elements from a liner, the tool is directed to face the bolt and/or nut of the mill, a photograph is taken with artificial vision for aligning the tool, the tool is fitted into the nut or bolt, the washer is tightened with the grips, and torque elimination is performed to thereby extract the fastening elements, holding them completely in the tool to be taken to a safe place for disposal.

The configuration of the automatic electric torque device or tool (1) with a large torque capacity and controlled speed for the extraction and installation of the fastening elements for a mill liner by means of an automatic manipulator allows moving the tool to an arrangement in which it is necessary to extract and/or introduce a fixing means for a mill liner by means of, for example, a robotic arm, to thereby carry out the method remotely, rendering the capacity to provide a movement in planes X, Y, and Z in order to compensate for deviations in the installation and/or extraction of the fastening means for mill liners, being able to hold cup washers through compression by the interference of its grips, and wherein it is capable of generating the necessary torque for the installation of the fixing means for a mill liner, measuring the torsion and the angle of installation, thereby providing a remotely-actuated, automated device or tool which allows to ensure process quality, certainty, and effectiveness, therefore optimizing the mill shutdown time for maintenance, and preventing maintenance personnel from being exposed to the risks associated with this type of method.

Although the configuration of the automatic electric torque device or tool (1) for the extraction and installation of the fixing means for a mill liner described herein constitutes a preferred inclusion of this invention, it should be understood that the invention is not limited to this precise form of the system for liner replacement, as changes can be made thereto without departing from the scope of the invention defined in the attached claims.

1. A remotely-actuated, automated electric torque device or tool with a large torque capacity and controlled speed for installation and/or extraction of fastening elements for mill liners, including washers, nuts, and/or bolts, comprising:
at least one powertrain;
at least one axial compensation means; and
at least one radial compensation means which render a capacity to provide a movement in planes X, Y, Z in order to compensate for deviations in the installation and/or extraction of the liner fixing means, at least one grip element, at least one tool exchanging means, at least one chassis, and at least one communication and control means which allows generating the necessary information and providing feedback to the system for operating the tool by means of different sensors arranged in the different components of the tool.

2. The automated electric torque device or tool according to claim 1, wherein the at least one radial compensation element comprises at least one pneumatic cylinder to generate a movement tolerance in directions X and Y of the tool so that it losses rigidity and helps in the fitting of a hexagon of the tool and the nut to be extracted, or in introducing the bolt in the thread of the liner.

3. The automated electric torque device or tool according to claim 1, wherein the at least one axial compensation means comprises at least one pneumatic cylinder to generate a movement tolerance in the axial direction in Z of the tool, allowing the fitting between the hexagon of the tool and the nut, also allowing the displacement of the nut during the removal of the bolt, in the extraction process, and at least one linear rail and at least one linear guide carriage over which the tool displaces.

4. The automated electric torque device or tool according to claim 1, wherein the at least one radial compensation element is arranged, attached, and/or fixed in an open front plate the chassis and allows rendering a movement in planes X and Y in order to compensate for deviations in the installation and/or extraction of the fastening elements of the mill liners.

5. The automated electric torque device or tool according to claim 1, wherein the at least one radial compensation means further comprises a gearbox casing and a first compensating plate which have central openings and are attached to one another by means of a vertically arranged pneumatic movement assembly formed by a cylinder support in which a pneumatic cylinder is arranged, wherein on both the upper edge and the lower edge of the gearbox casing opposite one another there are arranged said assemblies of cylinder support with the pneumatic cylinder and on each left and right side of said casing facing the first compensating plate, wherein there is arranged between each of said opposing assemblies of cylinder support and pneumatic cylinder a linear rail which is attached to linear guides with the recirculation of balls that are fixed to the opposing face of the first compensating plate, whereby movement tolerance in the direction of axis Y of the tool is generated.

6. The automated electric torque device or tool according to claim 1, wherein the at least one radial compensation means further comprises a horizontally arranged pneumatic movement assembly formed by a cylinder support in which a pneumatic cylinder is arranged on the rear face of the first compensating plate, such that at least two assemblies of support and pneumatic cylinder are fixed facing and spaced apart from one another between which there is arranged a linear rail which is attached to linear guides with the recirculation of balls that are fixed to the second compensating plate which is attached in the front part of the front plate of the chassis, whereby movement tolerance in the direction of axis X of the tool is generated.

7. The automated electric torque device or tool according to claim 1, wherein the at least one radial compensation means further comprises a valve arrangement with a manifold and a connector for operating the pneumatic movement assembly.

8. The automated electric torque device or tool according to claim 1, wherein the at least one axial compensation means further comprises a movement support assembly which is configured by a lateral retainer having at its ends a linear guide compensating stop to which a linear rail is attached, this assembly being fixed or attached on both sides to the rail support plate comprising the upper plate of the chassis and wherein there is attached to the linear rail a linear guide carriage which is fixed on the lower face of a guide support plate, on both sides of said plate, wherein said plate has a central recess in which at least one double-effect pneumatic cylinder is arranged and attached, whereby movement tolerance Z of the tool is generated.

9. The automated electric torque device or tool according to claim 1, wherein on the upper face of the guide support plate there is fixed an exchanger fastening plate that is attached to the tool exchanging means, the actuation of the cylinders being carried out by means of a valve having an air regulator with a connector.

10. The automated electric torque device or tool according to claim 1, wherein the chassis is configured by a series of elements attached to one another, such as opposing lateral plates that are spaced apart from one another, an upper plate and a front plate attached to one another through their edges by means of fastening elements forming a support structure with an inner housing, and the object thereof is to contain all the means and elements or subsystems that the device comprises, protect the tool, and structurally contain the forces and momentums generated due to the work of the electric torque device or tool.

11. The automated electric torque device or tool according to claim 1, wherein the upper plate comprises rail support plates on both sides, at least one lateral plate comprises an anchoring centering element attached thereto by means of fastening elements, a second compensating plate is attached in the front part of the front plate by means of the fastening elements and wherein both the front plate and said compensating plate comprise a central opening, furthermore the upper edge of the front plate comprises linear rail adjustment strips and the lower edge comprises lateral linear guide retainers.

12. The automated electric torque device or tool according to claim 1, wherein the front plate of the chassis has a configuration and shape such that it allows the fixing and/or attachment of the assembly of the at least one grip element and of at least one radial compensation element and the rear end of the open chassis has a shape and configuration allowing the fixing, arrangement, and/or attachment of the at least one powertrain means.

13. The automated electric torque device or tool according to claim 1, wherein the grip element is formed by a central ring having a central opening in which there are fixed, in a forwardly projecting manner, the grip fingers which are surrounded by an opening and closing actuation assembly formed by a bolt head or nut retention system, a grip piston, and a gripping cylinder, such that the grip piston, that is pneumatically actuated, is responsible for generating the closing and opening of the fingers of the grips that holds the washer or the bolt.

14. The automated electric torque device or tool according to claim 1, wherein the grip element is attached to the central opening of the gearbox casing of the radial compensation element and performs the function of holding the washer for installation and extraction, or allows grabbing the bolt in the case of liners with thread, and allows dissipating the torque from the reaction produced by the tool, so that it is not absorbed entirely by the robot.

15. The automated electric torque device or tool according to claim 1 wherein the powertrain means is formed by a servomotor which is attached to a planetary gearbox and this is in turn attached to the die, allowing the application of a torque and controlled speed according to process requirements, the servomotor comprises a power unit routing element attached at the rear end by means of fastening and sealing elements, and a servo mount in its front part through fastening and sealing elements, wherein said servo mount comprises a housing that is prolonged at the front part thereof in which there is housed an assembly formed by a spindle on which there are mounted on both opposite sides a ball rolling assembly and separator ring.

16. The automated electric torque device or tool according to claim 1, wherein the planetary gearbox comprises a central attachment element in its front part to which the die is attached by means of fastening and sealing elements, and wherein furthermore said planetary gearbox has a perimeter body ring with attachment holes along the entire perimeter thereof.

17. The automated electric torque device or tool according to claim 1, wherein the powertrain means transmits the torque from a drive system to the bolted attachment, generating the required tension.

18. The automated electric torque device or tool according to claim 1, wherein the tool exchanging means is formed by a base having a body formed by a central opening and a body perimeter having a series of holes for the fixing of fastening elements to be fixed to the exchanger fastening plate of the axial compensation means, wherein there are attached on the perimeter sides of the body of the base a module for water, a spacer, an electric module, a current module, a communications module, and adapters for expanding and installing modules.

19. The automated electric torque device or tool according to claim 1, wherein the communication and control means comprises at least one sensor and limit switch actuator, at least one open and closed grip sensor, at least one laser sensor for detecting movement in Z, and at least one die rotation sensor.
